(19) United States
(12) Patent Application Publication
(10) Pub. No.: US 2026/0349927 A1
(43) Pub. Date: Nov. 5, 2026

(54) SECURED ADDRESS TRANSLATION

(71) Applicant: Intel Products IP LLC, Santa Clara, CA (US)

(72) Inventors: Arie AHARON, Portland, OR (US); Raghunandan MAKARAM, Northborough, MA (US); Don C. SOLTIS, JR., Timnath, CO (US); Rupin H. VAKHARWALA, Hillsboro, OR (US); Ashish GUPTA, San Jose, CA (US); Anahit TARKHANYAN, Cupertino, CA (US); Philip LANTZ, Cornelius, OR (US); Reouven ELBAZ, Portland, OR (US); Ritika MATTHEW, Austin, TX (US)

(21) Appl. No.: 19/712,194

(22) Filed: Jun. 18, 2026

Related U.S. Application Data
(60) Provisional application No. 63/846,804, filed on Jul. 18, 2025.

(51) Int. Cl. G06F 12/10; G06F 21/62

(52) U.S. Cl. CPC G06F 12/10; G06F 21/6218; G06F 2212/7201

(57) ABSTRACT

Examples described herein relate to a root complex that includes: at least one port and circuitry. In some examples, the circuitry is to: based on a first configuration: based on receipt of a request to translate a virtual address to a physical address associated with a memory device and based on permission to access the physical address in the memory device, provide a translation of the virtual address to a second virtual address with an indicator that the translation comprises a virtual address and based on receipt of a second request to translate a third virtual address to a second physical address associated with a device and based on permission to access the device, provide a translation of the third virtual address to the second physical address.

### RELATED APPLICATION

This application claims priority from U.S. Provisional Application No. 63/846,804, filed Jul. 18, 2025. The entire content of that application is incorporated by reference in its entirety.

### DESCRIPTION

Computer systems store and access data from memory. Address translation translates logical addresses used by software into physical memory addresses. Use of logical addresses and address translations enable programs to access isolated virtual memory space. Peripheral Component Interconnect Express (PCIe) is a standardized, high-speed expansion bus interface used to connect internal hardware components to a motherboard. PCIe Address Translation Services (ATS) enable devices to request address translations from a Root Complex and cache the address translations in an Address Translation Cache (ATC).

### BRIEF DESCRIPTION OF THE DRAWINGS

FIG. 1 depicts an example system.

FIG. 2 depicts an example system.

FIG. 3 depicts an example of operations.

FIG. 4 shows an example process.

FIG. 5 shows an example process.

FIG. 6 depicts a system.

### DETAILED DESCRIPTION

Various examples can translate a guest logical address (e.g., guest physical address (GPA) or guest virtual address (GVA)) to a host physical address (HPA) for device-to-device communications (e.g., Memory-Mapped Input/Output (MMIO)) with direct peer-to-peer routing via a switch but translate a guest logical address to a modified guest logical address for device-to-memory accesses. For translation requests involving memory addresses that are permitted to be accessed by a requester device, ATS translation can return a guest logical address instead of an HPA but with an indicator that the returned guest logical address is not an HPA and is to be translated by a root complex or other device or software. For translation requests involving memory addresses that are not permitted to be accessed by the requester, ATS translation can indicate to the requester device that the requester is not permitted to receive an address translation. Herein, a guest logical address can refer to a GPA, GVA, or other logical address.

For example, an Input-Output Memory Management Unit (IOMMU) can operate in at least two modes. In a partial translation mode, a translation of a guest logical address to access a memory can return a partially translated guest logical address with an indicator the translation is a partial translation. For partial translation mode, an IOMMU access control rule can be if a guest logical address indicator is modified or indicates that the guest logical address is a partial translation, IOMMU can identify the guest logical address as untranslated even if it arrives as appearing to be translated. This mode can reduce latency for guest logical address accesses but a device may not be able to differentiate that a returned translation is an HPA or guest logical address.

For a second mode, the IOMMU may not perform a translation for accesses to host memory and can return the guest logical address (e.g., receive GVA and return GVA or receive GPA and return GPA) and indicate the guest logical address is untranslated using PCIe ATS Transaction Layer Packet (TLP) Completion U bit. For the second mode, IOMMU access control rule can block translation of guest logical addresses that access memory. An example PCIe specification can include PCI Special Interest Group (PCI-SIG), PCI Express Base Specification Revision 5.0, Version 1.0, Beaverton, OR (May 2019), and earlier versions, later versions, or variations thereof.

A switch or other circuitry can route memory reads or writes with the modified guest logical address to a root complex so that the root complex can selectively provide a modified guest logical address-to-HPA translation based on whether the requester device is permitted to access the memory address. For example, when an address of a communication falls into a configured address range, the switch can route the communication to a destination endpoint or when the address includes an indicator the address is not a guest logical address, the switch can route the communication to the root complex for translation to an HPA.

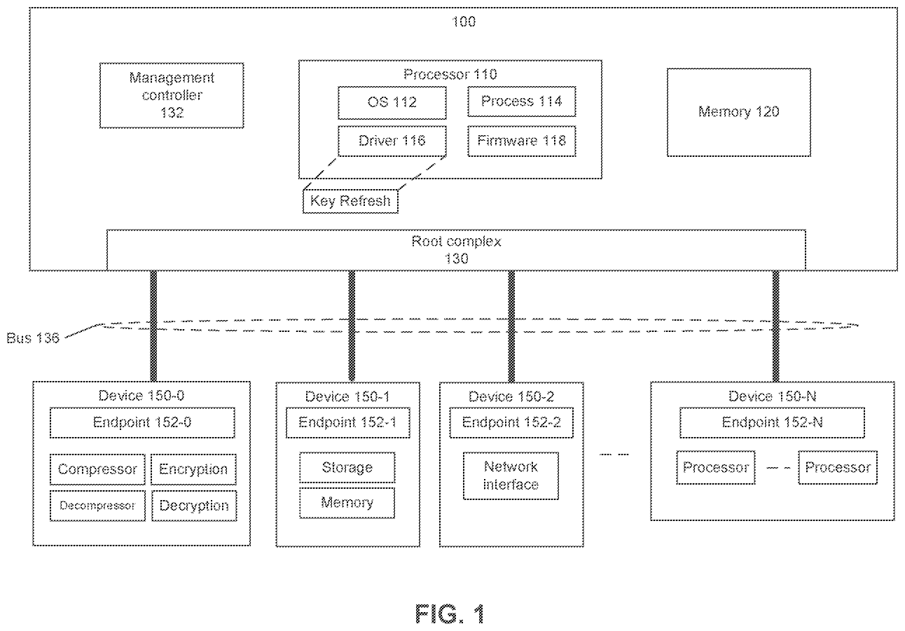

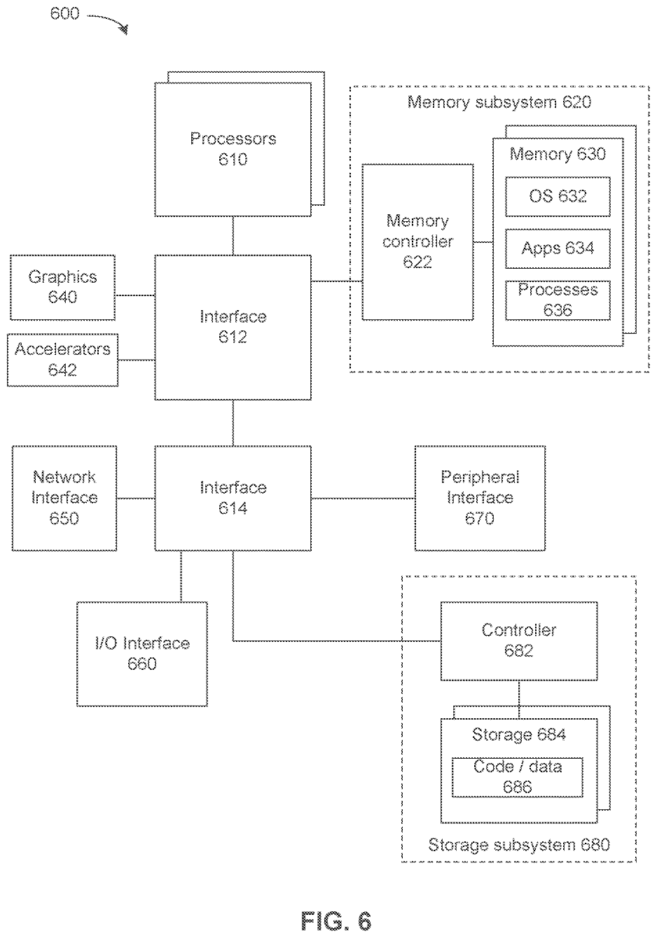

FIG. 1 depicts an example system. Host 100 can include one or more processors 110, memory 120, and other circuitry and software described at least with respect to FIG. 6. Processors 110 can execute at least one or more of: operating system (OS) 112, processes 114, driver 116, firmware 118, and other software. Driver 116 can provide a communication interface between OS 112 and root complex 130 and/or one or more of devices 150-0 to 150-N, where N is an integer. Processes 114 can include one or more of: an application, process, thread, a virtual machine (VM), microVM, container, microservice, virtual function (VF), virtual device, or other virtualized execution environment.

Processes 114 can access devices 150-0 to 150-N as PCIe endpoints 152-0 to 152-N using a component interconnect bus 136 via root complex 130. The PCIe protocol is described at least in Peripheral Component Interconnect (PCI) Express Base Specification 1.0 (2002), as well as earlier versions, later versions, and variations thereof. Processor 110 can access one or more of devices 150-0 to 150-N as Single Root I/O Virtualization (SR-IOV) virtual functions (VFs) or Scalable I/O Virtualization (SIOV) Assignable Device Interfaces (ADIs).

In some examples, component interconnect bus 136 can provide one or more parallel lanes of data paths for serial and point-to-point communication between two devices (e.g., motherboard and expansion card); data transfer rate is based on a generation number of an applicable standard and number of lanes; backward compatibility with older generations of the applicable standard; hot-plug capability to add or remove a connected device without restarting a host system; slots are mechanically capable of more lanes than are active; or others.

Devices 150-0 to 150-N can include one or more of: an accelerator, graphics processing unit (GPU), storage device, network interface device, or other circuitry. For example, an accelerator can perform cryptographic, compression, or decompression operations on data stored in memory 120. Memory 120 can include one or more registers, volatile memory, non-volatile memory, cache, or other circuitry.

Root complex 130 can provide a fabric and interface among processor 110, memory 120, devices 150-0 to 150-N, and/or other devices (e.g., management controller 132). Root complex 130 can include one or more root ports, which can include physical or logical connections to a PCIe fabric. While the example shows a root complex for a host system, root complex 130 can be used in a switch or other device. In some examples, root complex 130 and component interconnect bus 136 can provide communications among processors 110 and devices 150-0 to 150-N using one or more lanes in a manner that is consistent at least with PCI Express (PCIe), Compute Express Link (CXL), NVMe over Fabrics (NVMe-oF), or other standards. Other standards can include at least: Advanced Micro Devices, Inc. (AMD) HyperTransport, NVIDIA® NVLink, Intel® QuickPath Interconnect (QPI), Advanced Microcontroller Bus Architecture (AMBA), Coherent Hub Interface (CHI) Chip to Chip (C2C), TileLink, RISC-V processor interconnect, Intel® Ultra Path Interconnect (UPI), Intel® On-Chip System Fabric (IOSF), Omnipath, or others.

PCIe Shared Virtual Memory (SVM) allows devices to use a same GVA pointer that the process running on a processor is using. PCIe supports SVM via (1) ATS for translations, page request interface (PRI), PCIe protocol request response protocol to allow devices to induce page faults into the host operating system (OS) and handle translation request failures, and use Process Address Space ID (PASID), which allows the application executing on the processor and the device to define a context identifier (ID) for page translation and request services. With SVM, GVA translation can be modified to provide partial GVA to GPA in partial translation mode. SVM is described at least in PCI Special Interest Group (PCI-SIG), PCI Express Base Specification Revision 3.1, Beaverton, OR (November 2014), and earlier versions, later versions, or variations thereof.

PCIe SVM enables devices to directly interact with data structures (e.g., lists, graphs, or others) without kernel-mode drivers to copy or reconstruct the data structures, even when the device and host operate in different address spaces. Root complex 130 can include Input-Output Memory Management Unit (IOMMU). IOMMU can translate virtual addresses and provide address translations for devices to access memory 120 through Direct Memory Access (DMA) or access other devices. When a device performs a DMA read or write operation, the device sends the request to the IOMMU and the IOMMU translates the address to a host physical address (HPA). A device can send an ATS Translation Request to IOMMU or System Memory Management Unit (SMMU) when a device is to access memory 120 for DMA but its local Address Translation Cache (ATC) does not have the virtual-to-physical address mapping.

In some examples, for MMIO direct peer-to-peer (P2P) communications between devices and where the communications between devices is permitted in a configuration, the IOMMU can return an HPA for address translation requests. A range of addresses can be associated with devices so that devices can be accessed by MMIO. Using MMIO, processor 110 can use memory read (load) and write (store) operations to access devices. MMIO accesses peripheral devices as memory locations, allowing a device to access the peripheral devices using memory access instructions. When accessing the target device by accessing the MMIO address, the source device sends the requests with the HPA. Devices can directly access data from other devices via a PCIe switch, described herein, and bypass processor 110. Direct P2P can reduce latency (e.g., shorter distance between devices) and reduced bandwidth (e.g., avoid processor being the bottle neck for data transport between devices).

With address translation and allowing untranslated request from a device, the device could send a translated request (e.g., HPA) to access memory in an unauthorized manner. In addition, or alternatively, a compromised switch or interposer could change or fake memory requests, allowing unauthorized access to memory 120. In some cases, OS 112 and Virtual Machine Monitor (VMM) security models aim to reduce the Trusted Computing Base (TCB) and apply zero-trust principles to reduce capability to access memory or devices. In order to secure access a memory address in memory 120 from unauthorized access, root complex 130 may not translate a GPA to an HPA. Instead, for a requested translation of an address in memory from an authorized requester, IOMMU can return a GPA with an indicator that the address is a GPA, instead of an HPA. The indicator can be an unused address bit (e.g., MAX_PA) set to 1 or 0 or others. For a requested translation of an address in memory from an unauthorized requester, IOMMU can deny the translation and indicate the request to translate an address was denied.

For example, the Address Type (AT) field in a PCIe Transaction Layer Packet (TLP) header can indicate whether the memory address provided in the transaction is translated (from virtual to physical address) or untranslated. In some examples, ATS encodes a returned address to indicate to a requester that the returned address is untranslated. For example, the indication that the returned address is untranslated can be made by invalid bit combinations, unused field, or others.

Subsequently, based on the source device requesting access to the GPA in memory 120, a switch can cause the GPA with indicator to be routed to root complex 130. For a configuration in which the source device is permitted to access the HPA, root complex 130 can decode the GPA with indicator to an HPA by use of an Input-Output Translation Lookaside Buffer (IOTLB) or page tables.

Devices 150-0 to 150-N can include an on-device Input-Output Translation Lookaside Buffer (IOTLB) that operates in a manner consistent with PCIe Address Translation Cache (ATC). Instead of the IOMMU performing a full page table walk for translation requests, a device can request a translation once and cache the result in a TLB, and use the resolved HPA directly in its subsequent device or memory write or read communications (e.g., Transaction Layer Packets (TLPs)). During translation, the IOMMU can proactively load the GPA-to-HPA mapping into the IOTLB, increasing hit rate and reducing latency on subsequent memory accesses. However, a source device may determine to not cache an untranslated returned address in an IOTLB as the returned address is not an address translation.

While examples are described with respect to providing untranslated responses for requests to translate addresses in memory, the examples can apply to requests to translate MMIO addresses that access devices.

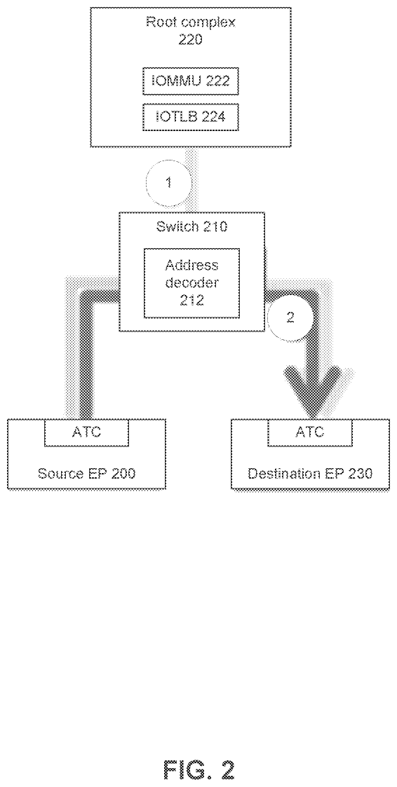

FIG. 2 depicts an example of operations. IOMMU 222 of root complex 220 can translate a GPA to an HPA or a GPA to a GPA with an indicator, as described herein. A GPA-to-HPA mapping can be stored into IOTLB 224 for the device's Requester ID (RID), marked as a valid cache entry with page-level attributes (e.g., permissions, domain, etc.), and retained in IOTLB 224 until eviction or invalidation, thereby increasing the likelihood that subsequent DMA using the GPA will hit in the cache and delays from ATS can be avoided.

Process Address Space identifier (PASID) allows devices to issue memory transactions tied to a specific process address space, such as for a process within a particular virtual machine (VM) or Trust Domain (TD). A VM address space can include GPAs whereas a specific process or application within a VM can have a dedicated PASID and GVA space. In some examples, root complex 220 can selectively flush IOMMU translation entries associated with a specific PASID, instead of performing a full IOTLB flush.

Source endpoint (EP) 200 can transmit a request through switch 210 to communicate with destination EP 230 and destination EP 230 can transmit a request through switch 210 to communicate with source EP 200. Switch address decoder 212 can determine whether to forward the request through route (1) or route (2). Route (1) can originate at SRC EP 200, traverse switch 210, root complex 220, and traverse switch 210 to destination EP 230. Route (2) can include originate at SRC EP 200, and traverse switch 210 to DST EP 230.

For route (1), source EP 200 can request an address translation in a PCIe Translation Request to root complex 220. Source EP 200 can send a Transaction Layer Packet (TLP) with a GPA address to root complex 220. IOMMU 222 of root complex 220 can translate the GPA to an HPA while enforcing the permissions set by the host VMM that permits or denies translation of the GPA to an HPA by requester and address. For accesses to memory, ATS can return to source EP 200 a GPA instead of an HPA in an Translation Completion. When IOMMU 222 returns ATS translations with a GPA, an indicator can be set to attempt to avoid aliasing with a valid GPA for MMIO and to indicate the returned address is not an HPA. In some examples, if source EP 200 issues a memory access request with an address that falls into the default upstream Integrated Development Environment (IDE) configured in switch address decoder 212, switch 210 can route the memory access request to root complex 220.

For a subsequent memory access to the GPA with the indicator from source EP 200, switch 210 can route the memory access with the indicator to root complex 220 so that IOMMU 222 can enforce isolation policies by selectively translating the GPA with indicator to an HPA if source EP 200 or software executed by source EP 200 is permitted to access the HPA. Root complex 220 can use an IOTLB or page tables to translate the GPA with indicator to an HPA in host memory. The memory device can be on-chip with a root complex that performs translation, or accessible using a device interface such as PCIe.

For the second mode, IOMMU access control rule can block translation of guest logical addresses that access memory. The IOMMU may indicate a returned guest logical address is untranslated using PCIe ATS Transaction Layer Packet (TLP) Completion U bit.

For MMIO direct P2P mode, IOMMU 222 can return to source EP 200 an HPA for device translation requests. For a subsequent access to the HPA, switch 210 can route HPA-based MMIO traffic to destination EP 230 and bypass root complex 220 in route (2). Based on a stream address range configured in address decoder 212 for P2P Integrity and Data Encryption (IDE) stream address range (e.g., virtual private network), switch 210 can route a second stream in route (2) between SRC EP 200 and DST EP 230 for peer-to-peer routing.

Accordingly, various operations of IOMMU 222 for partial translation mode can be as follows.

| Example | | |
|---|---|---|
| mode | RC-Routed P2P (route 1) | Direct P2P via Switch (route 2) |
| IOMMU | Disabled. ATS returns GPA in | Enabled. ATS return HPA for MMIO |
| Partial | response to translation request | High (HPA >=128 GB), and GPA for |
| Translation | | DRAM and MMIO Low (HPA <128 GB) |
| Direct P2P | | |
| Mode | | |
| Switch ACS | P2P Request Redirect = 1 | P2P Request Redirect = 0 |
| Configuration | P2P Completion Redirect = 1 | P2P Completion Redirect = 0 |
| | Upstream Forwarding = 1 | Upstream Forwarding = 0/1 |
| P2P MMIO | Peer-to-peer MMIO traffic | MMIO falls into device P2P IDE stream |
| Traffic | routed through Root Complex | address range and into switch direct P2P |
| Routing | | address decoder |
| Switch | Memory addresses GPA with MAX_PA = 1 | |
| Memory | fall into default IDE stream and switch | |
| Traffic | default decoding and routed to the RC. | |
| Routing | | |

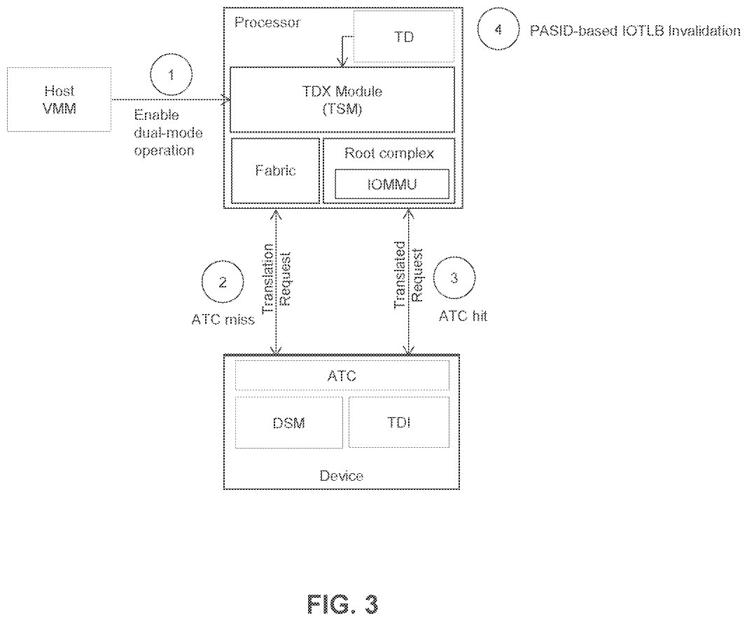

FIG. 3 depicts an example of operations to configure address translations of a root complex. At (1), a VMM can configure ATS operations in a root complex to perform GPA-to-modified GPA translations for memory accesses or GPA-to-HPA translations for device-to-device communications. For example, to enable such ATS operations, VMM can enumerate ATS enabling and access control support by setting Device-TLB Enable (DTE) and Address Space Tagged TLB (ATSPT) tags in trusted context table entry of Trust Domain Extensions (TDX) module. A DTE tag can be a configuration flag within an IOMMU Context Entry that controls the use of device-level translation caches to accelerate DMA operations. ATSPT can tag TLBs with an Address Space Identifier (ASID) or Process Identifier (PID), which allows translations for multiple processes to coexist in the TLB without a full TLB flush (invalidation) during a context switch.

At (2), for an address translation cache (ATC) miss by a device, the device sends an address translation request to IOMMU and IOMMU bypasses IOTLB and translates the requested address based on the device having permission to receive an address translation. If MMIO mode is disabled and HPA is not an MMIO, IOMMU can return a GPA with an indicator that the returned address is a GPA. If the IOMMU returns an HPA to the device, the IOMMU can cache the translation of GPA to HPA in an IOTLB.

At (3), for an ATC hit whereby the device caches a translation of the GPA to an HPA, but the translation is actually to a GPA, the device sends a request with the address in the ATC to a switch, described earlier. The switch can forward the request to the root complex. With ATS partial translation mode enabled, IOMMU can translate the provided guest logical address to a HPA based on the device having permission to receive an address translation. If MMIO P2P mode is enabled and if the device sends translated requests without an indicator that the address is a GPA, IOMMU can issue a fault.

At (4), PASID-based IOTLB invalidation can be performed. To invalidate entries in a TLB for a particular PASID, if nested (e.g., first and second) translation is enabled for a TD, a TDX module or hypervisor can intercept guest PASID-based IOTLB invalidations and replace them with global PASID and device identifier (DID) invalidation. Device Security Manager (DSM) and Trusted Device Interface (TDI) of device can coordinate with TSM of processor to enforce security policies and invalidate the proper TLB entries.

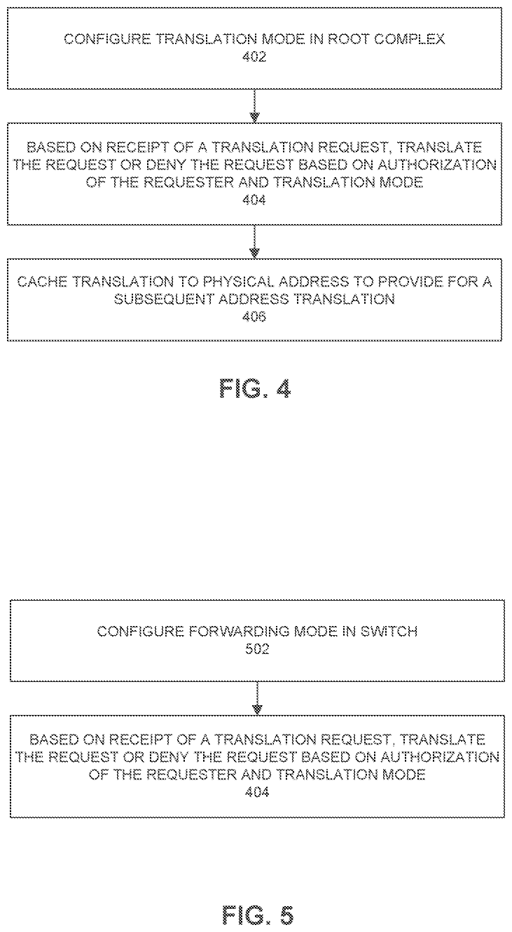

FIG. 4 depicts an example process. The process can be performed by a root complex in some examples. At 402, dual translation mode can be enabled for virtual-to-physical address translations. Dual translation mode can cause address translation requests for accessing a device to cause translation of a virtual address (e.g., GPA) to a physical address (e.g., HPA) or no translation of a virtual address, but cause address translation requests for accessing a memory to cause translation of a virtual address to a second virtual address with an indicator that the second virtual address is to be translated to a physical address by a root complex.

At 404, based on receipt of a request for virtual address to physical address translation, address translation can be performed. Based on enablement of dual translation mode, for receipt of a request to translate a virtual address to a physical address in a memory and the requester is authorized to receive a translated address, a second virtual address can be provided to the requester with an indicator that the second virtual address is not a translation to a host physical address, or return the untranslated second virtual address. Based on enablement of dual translation mode, for receipt of a request to translate a virtual address to a physical address in a device and the requester is authorized to receive a translated address, a host physical address can be provided to the requester. A requester can include a device or software executed by the device.

At 404, based on disablement of dual translation mode, for receipt of a request to translate a virtual address to a physical address in a memory or device and the requester is authorized to receive a translated address, a host physical address, corresponding to the virtual address, can be provided to the requester.

At 406, the translation of a virtual address to physical address or second virtual address can be stored in an address translation cache. The translation can be of a virtual address to physical address in a memory, a virtual address to a second virtual address, or associated with a device using MMIO.

FIG. 5 depicts an example process. The process can be performed by a switch in some examples. At 502, a switch can be configured to perform routing of memory access requests to a root complex for address translation or forwarding of device access requests to a target device. At 504, based on receipt of a memory access request, the switch can route the memory access request depending on whether the receiver is a memory device or device. For a receiver that is a memory device, an address in the memory access request can include address with an indicator that the address is a virtual address and not a host physical address and the switch can detect such indicator and cause the memory access request to be routed to a root complex for address translation. For a receiver that is the memory device, an address in the memory access request can include a virtual address that was not translated.

After address translation, the memory access request with host physical address can be forwarded to the memory device. For a receiver that is a device, an address in the memory access request can include host physical address and the switch can cause the memory access request to be routed to the device.

FIG. 6 depicts a system. The system can use examples to perform dual mode address translation and memory and device access request forwarding, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the artificial intelligence (AI) model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

For example, processors 610 can advertise capabilities of an IOMMU to perform dual mode address translation, as described herein. OS 632, firmware, or a driver can enable or disable the capabilities by calling an application programming interface (API).

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device. In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize an interposer, switch, or silicon bridge that provides communication between dies. For example, die-to-die communications can be provided by an Embedded Multi-die Interconnect Bridge (EMIB), Chip-on-Wafer-on-Substrate (CoWoS), or other devices. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more later examples and includes an apparatus that includes: a root complex comprising: at least one port and circuitry, wherein the circuitry is to: based on a first configuration: based on receipt of a request to translate a virtual address to a physical address associated with a memory device and based on permission to access the physical address in the memory device, provide a translation of the virtual address to a second virtual address with an indicator that the translation comprises a virtual address and based on receipt of a second request to translate a third virtual address to a second physical address associated with a device and based on permission to access the device, provide a translation of the third virtual address to the second physical address.

Example 2 includes one or more later examples or an earlier example, wherein: based on a third request to translate the second virtual address with the indicator and based on permission to access the physical address in the memory device, provide the physical address.

Example 3 includes one or more later examples or one or more earlier examples, wherein a response to the request to translate the virtual address to the physical address associated with the memory device is to indicate that an address translation was not performed.

Example 4 includes one or more later examples or one or more earlier examples, wherein the indicator comprises a value in an unused address bit in the second virtual address, a value in an otherwise unused field, or invalid bit combination.

Example 5 includes one or more later examples or one or more earlier examples, wherein: based on a second configuration: based on receipt of a request to translate a fourth virtual address to a fourth physical address associated with a memory device or the device and based on permission to access the memory device or the device, provide a translation of the fourth virtual address to the fourth physical address.

Example 6 includes one or more later examples or one or more earlier examples, and includes a switch configured to: when an address of a communication falls into an address range, route the communication to a destination endpoint and when the address is received with the indicator, route the communication to the root complex for translation to a host physical address.

Example 7 includes one or more later examples or one or more earlier examples, and includes an Input-Output Memory Management Unit (IOMMU) to perform virtual to physical address translations.

Example 8 includes one or more later examples or one or more earlier examples, and includes a system that includes: a root complex that includes: at least one port and an Input-Output Memory Management Unit (IOMMU) to perform virtual to physical address translation for Peripheral Component Interconnect Express (PCIe) for Address Translation Services (ATS), wherein to perform ATS, the IOMMU is to: based on a first configuration: based on receipt of a request to translate a virtual address to a physical address associated with a memory device and based on permission to access the physical address in the memory device, provide a translation of the virtual address to a second virtual address with an indicator that the translation comprises a virtual address and based on receipt of a second request to translate a third virtual address to a second physical address associated with a device and based on permission to access the device, provide a translation of the third virtual address to the second physical address.

Example 9 includes one or more later examples or one or more earlier examples, wherein: based on a third request to translate the second virtual address with the indicator and based on permission to access the physical address in the memory device, provide the physical address.

Example 10 includes one or more later examples or one or more earlier examples, wherein a response to the request to translate the virtual address to the physical address associated with the memory device is to indicate that an address translation was not performed.

Example 11 includes one or more later examples or one or more earlier examples, wherein the indicator comprises a value in an unused address bit in the second virtual address, a value in an otherwise unused field, or invalid bit combination.

Example 12 includes one or more later examples or one or more earlier examples, wherein: based on a second configuration: based on receipt of a request to translate a fourth virtual address to a fourth physical address associated with a memory device or the device and based on permission to access the memory device or the device, provide a translation of the fourth virtual address to the fourth physical address.

Example 13 includes one or more later examples or one or more earlier examples, and includes a switch configured to: when an address of a communication falls into an address range, route the communication to a destination endpoint and when the address is received with the indicator, route the communication to the root complex for translation to a host physical address.

Example 14 includes one or more later examples or one or more earlier examples, wherein the address range comprises a range of addresses that a device is permitted to access.

Example 15 includes one or more later examples or one or more earlier examples, and includes a method that includes: based on a first configuration: based on receipt of a request to translate a virtual address to a physical address associated with a memory device and based on permission to access the physical address in the memory device, providing a translation of the virtual address to a second virtual address with an indicator that the translation comprises a virtual address and based on receipt of a second request to translate a third virtual address to a second physical address associated with a device and based on permission to access the device, providing a translation of the third virtual address to the second physical address.

Example 16 includes one or more later examples or one or more earlier examples, wherein: based on a third request to translate the second virtual address with the indicator and based on permission to access the physical address in the memory device, providing the physical address.

Example 17 includes one or more later examples or one or more earlier examples, wherein a response to the request to translate the virtual address to the physical address associated with the memory device is to indicate that an address translation was not performed.

Example 18 includes one or more later examples or one or more earlier examples, wherein the indicator comprises a value in an unused address bit in the second virtual address, a value in an otherwise unused field, or invalid bit combination.

Example 19 includes one or more later examples or one or more earlier examples, and includes based on a second configuration: based on receipt of a request to translate a fourth virtual address to a fourth physical address associated with a memory device or the device and based on permission to access the memory device or the device, providing a translation of the fourth virtual address to the fourth physical address.

Example 20 includes one or more earlier examples, wherein the address translation is based on Peripheral Component Interconnect Express (PCIe) for Address Translation Services (ATS).

1. An apparatus comprising:
a root complex comprising:
at least one port and
circuitry, wherein the circuitry is to:
based on a first configuration:
based on receipt of a request to translate a virtual address to a physical address associated with a memory device and based on permission to access the physical address in the memory device, provide a translation of the virtual address to a second virtual address with an indicator that the translation comprises a virtual address and
based on receipt of a second request to translate a third virtual address to a second physical address associated with a device and based on permission to access the device, provide a translation of the third virtual address to the second physical address.

2. The apparatus of claim 1, wherein:
based on a third request to translate the second virtual address with the indicator and based on permission to access the physical address in the memory device, provide the physical address.

3. The apparatus of claim 1, wherein a response to the request to translate the virtual address to the physical address associated with the memory device is to indicate that an address translation was not performed.

4. The apparatus of claim 1, wherein the indicator comprises a value in an unused address bit in the second virtual address, a value in an otherwise unused field, or invalid bit combination.

5. The apparatus of claim 1, wherein:
based on a second configuration:
based on receipt of a request to translate a fourth virtual address to a fourth physical address associated with a memory device or the device and based on permission to access the memory device or the device, provide a translation of the fourth virtual address to the fourth physical address.

6. The apparatus of claim 1, comprising:
a switch configured to:
when an address of a communication falls into an address range, route the communication to a destination endpoint and
when the address is received with the indicator, route the communication to the root complex for translation to a host physical address.

7. The apparatus of claim 1, comprising an Input-Output Memory Management Unit (IOMMU) to perform virtual to physical address translations.

8. A system comprising:
a root complex comprising:
at least one port and
an Input-Output Memory Management Unit (IOMMU) to perform virtual to physical address translation for Peripheral Component Interconnect Express (PCIe) for Address Translation Services (ATS), wherein to perform ATS, the IOMMU is to:
based on a first configuration:
based on receipt of a request to translate a virtual address to a physical address associated with a memory device and based on permission to access the physical address in the memory device, provide a translation of the virtual address to a second virtual address with an indicator that the translation comprises a virtual address and
based on receipt of a second request to translate a third virtual address to a second physical address associated with a device and based on permission to access the device, provide a translation of the third virtual address to the second physical address.

9. The system of claim 8, wherein:
based on a third request to translate the second virtual address with the indicator and based on permission to access the physical address in the memory device, provide the physical address.

10. The system of claim 8, wherein a response to the request to translate the virtual address to the physical address associated with the memory device is to indicate that an address translation was not performed.

11. The system of claim 8, wherein the indicator comprises a value in an unused address bit in the second virtual address, a value in an otherwise unused field, or invalid bit combination.

12. The system of claim 8, wherein:
based on a second configuration:
based on receipt of a request to translate a fourth virtual address to a fourth physical address associated with a memory device or the device and based on permission to access the memory device or the device, provide a translation of the fourth virtual address to the fourth physical address.

13. The system of claim 8, comprising:
a switch configured to:
when an address of a communication falls into an address range, route the communication to a destination endpoint and
when the address is received with the indicator, route the communication to the root complex for translation to a host physical address.

14. The system of claim 13, wherein the address range comprises a range of addresses that a device is permitted to access.

15. A method comprising:
based on a first configuration:
based on receipt of a request to translate a virtual address to a physical address associated with a memory device and based on permission to access the physical address in the memory device, providing a translation of the virtual address to a second virtual address with an indicator that the translation comprises a virtual address and
based on receipt of a second request to translate a third virtual address to a second physical address associated with a device and based on permission to access the device, providing a translation of the third virtual address to the second physical address.

16. The method of claim 15, wherein:
based on a third request to translate the second virtual address with the indicator and based on permission to access the physical address in the memory device, providing the physical address.

17. The method of claim 15, wherein a response to the request to translate the virtual address to the physical address associated with the memory device is to indicate that an address translation was not performed.

18. The method of claim 15, wherein the indicator comprises a value in an unused address bit in the second virtual address, a value in an otherwise unused field, or invalid bit combination.

19. The method of claim 15, comprising:
based on a second configuration:
based on receipt of a request to translate a fourth virtual address to a fourth physical address associated with a memory device or the device and based on permission to access the memory device or the device, providing a translation of the fourth virtual address to the fourth physical address.

20. The method of claim 15, wherein the address translation is based on Peripheral Component Interconnect Express (PCIe) for Address Translation Services (ATS).
